(19) United States
(12) Patent Application Publication
(10) Pub. No.: US 2024/0262757 A1
(43) Pub. Date: Aug. 8, 2024

(54) SILICON CARBIDE DIRECT SILICON SURFACE POLISH

(71) Applicant: ENTEGRIS, INC., Billerica, MA (US)

(72) Inventors: Shandon T. Fullingim, Decatur, TX (US); Hugo Vargas, Fort Worth, TX (US)

(21) Appl. No.: 18/383,379

(22) Filed: Oct. 24, 2023

Related U.S. Application Data
(60) Provisional application No. 63/419,158, filed on Oct. 25, 2022.

(51) Int. Cl. C04B 41/50; C04B 35/565; C04B 38/00; C04B 41/53

(52) U.S. Cl. CPC C04B 41/5096; C04B 35/565; C04B 38/0054; C04B 41/53

(57) ABSTRACT

The present disclosure includes a method of forming a polished surface. Forming the polished surface can include grinding an initial ceramic substrate to form a ground ceramic substrate; infiltrating the ground ceramic substrate with silicon; and polishing the silicon-infiltrated ceramic substrate, thereby forming the polished surface.

### FIELD

The present disclosure relates to the field of polishing a surface.

### BACKGROUND

Coatings can be used to modify a surface, such as a substrate surface.

### SUMMARY

The application of a dense chemical vapor deposited (CVD) silicon carbide cladding layer (sometimes referred to as a “coating”) on porous silicon carbide substrates can be potentially problematic. In some examples, the cladding layer on the substrate can require the use of complex design tolerance. The cladding layer may require significant processing and fixturing costs to apply.

A need exists in optics and other industries for a critical surface to be polished in a cost-effective manner without significant processing. One example is a high speed, critical printing. The polishing method can also be used as a cost reduction in silicon carbide grinding if a substantial layer of silicon can be layered on a surface.

In some methods of the present disclosure, the method includes a silicon carbide converted part that has its to-be-polished surfaces pre-ground on the order of a thousandths of an inch prior to silicon-infiltration. During silicon-infiltration, the silicon floats/wicks to the top pre-ground surface. After silicon-infiltration, the part is sent to have the thin silicon layer polished to a final figure.

In some embodiments, the present disclosure relates to a method of forming a polished surface: grinding an initial ceramic substrate to form a ground ceramic substrate; infiltrating the ground ceramic substrate with silicon; and polishing the silicon-infiltrated ceramic substrate, thereby forming the polished surface of the polished silicon-infiltrated ceramic substrate.

In some embodiments, the present disclosure relates to a method including polishing the silicon-infiltrated ceramic substrate includes polishing to have a surface finish of less than 150 angstroms root-mean-squared.

In some embodiments, the present disclosure relates to a method including polishing the silicon-infiltrated ceramic substrate includes polishing to have a surface finish of less than 100 angstroms root-mean-squared.

In some embodiments, the present disclosure relates to a method including polishing the silicon-infiltrated ceramic substrate includes polishing to have a surface figure of less 500 nm.

In some embodiments, the present disclosure relates to a method including polishing the silicon-infiltrated ceramic substrate includes polishing to have a surface figure of less 200 nm.

In some embodiments, the present disclosure relates to a method including after infiltrating the ground ceramic substrate with silicon, removing excess silicon.

In some embodiments, the present disclosure relates to a method including the polished surface includes a porosity with an average pore size ranging from 50 microns to 20 microns.

In some embodiments, the present disclosure relates to a method including the polished surface includes a porosity with an average pore of size of 50 microns.

In some embodiments, the present disclosure relates to a method including the polished surface includes a porosity with an average pore of size of 30 microns.

In some embodiments, the present disclosure relates to a method including the polished surface includes a porosity with an average pore of size of 20 microns.

In some embodiments, the present disclosure relates to a method including the polished surface extends less than 100 microns into the polished silicon-infiltrated ceramic substrate.

In some embodiments, the present disclosure relates to a method including grinding the initial ceramic substrate to form the ground ceramic substrate includes grinding the ground ceramic substrate to be less than 4 thousandths of an inch.

In some embodiments, the present disclosure relates to a method of forming a polished surface: grinding an initial ceramic substrate to form a ground ceramic substrate; forming silicon carbide within pores of the ground ceramic substrate, thereby forming a silicon-infiltrated ceramic substrate; and polishing the silicon-infiltrated ceramic substrate, thereby forming the polished surface of the polished silicon-infiltrated ceramic substrate.

In some embodiments, the present disclosure relates to a method including forming the silicon carbide within the pores includes: infiltrating the ground ceramic substrate with a carbon-based resin liquid; heating the ground ceramic substrate with the carbon-based resin liquid to form carbon powder in pores of the ground ceramic substrate; infiltrating the pores of the ground ceramic substrate with silicon; and reacting the silicon with the carbon powder to form the silicon carbide within the pores.

In some embodiments, the present disclosure relates to a method including polishing the silicon-infiltrated ceramic substrate includes polishing to have a surface finish of less than 150 angstroms root-mean-squared.

In some embodiments, the present disclosure relates to a method including polishing the silicon-infiltrated ceramic substrate includes polishing to have surface finish of less than 100 angstroms root-mean-squared.

In some embodiments, the present disclosure relates to a method including polishing the silicon-infiltrated ceramic substrate includes polishing to have a surface figure of less 500 nm.

In some embodiments, the present disclosure relates to a method including polishing the silicon-infiltrated ceramic substrate includes polishing to have a surface figure of less 200 nm.

In some embodiments, the present disclosure relates to a method including, after infiltrating the ground ceramic substrate with silicon, removing excess silicon.

In some embodiments, the present disclosure relates to a method including the polished surface includes porosity with an average pore size ranging from 50 microns to 20 microns.

In some embodiments, the present disclosure relates to a method including the polished surface includes a porosity with an average pore of size of 30 microns.

In some embodiments, the present disclosure relates to a method including the polished surface includes a porosity with an average pore of size of 20 microns.

In some embodiments, the present disclosure relates to a method including the polished surface extends less than 100 microns into the polished silicon-infiltrated ceramic substrate.

In some embodiments, the present disclosure relates to a method including grinding the initial ceramic substrate to form the ground ceramic substrate includes grinding the ground ceramic substrate to be less than 4 thousandths of an inch.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting embodiment of a method of the present disclosure described herein.

FIG. 2 depicts a non-limiting embodiment of a method of the present disclosure described herein.

FIG. 3 depicts a non-limiting embodiment of a method of the present disclosure described herein.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “surface figure” is the difference in height between the highest and lowest points on the surface.

As used herein, the term “surface finish” describes the average deviation of the surface figure from the desired surface.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

As used herein “embedded” means that a first material is distributed throughout a second material.

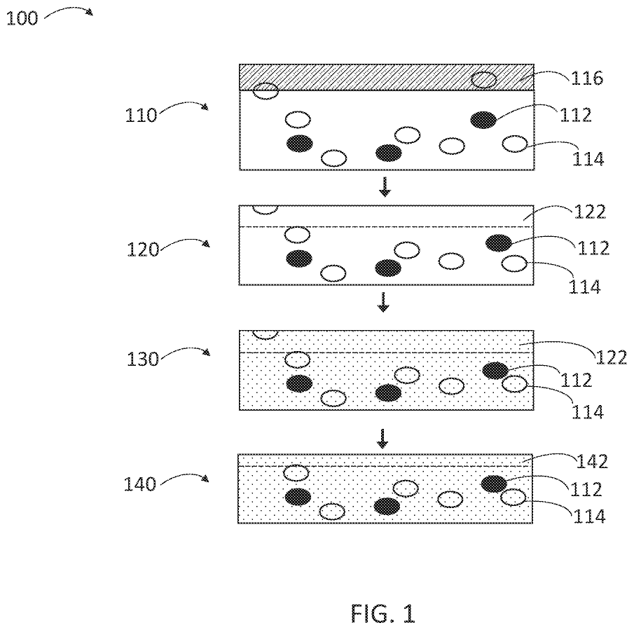

FIG. 1 depicts a non-limiting embodiment of a method 100 of the present disclosure described herein. In some embodiments, the method 100 includes an initial ceramic substrate 110 with a removable area 116, closed pores 112, and open pores 114. The open pores 114 are dispersed throughout the initial ceramic substrate 110.

In some embodiments, the initial ceramic substrate 110 is a silicon carbide substrate.

The initial ceramic substrate 110 is porous. In some embodiments, the initial ceramic substrate 110 is at least 5% porous, at least 10% porous, at least 15% porous, at least 20% porous, at least 25% porous, at least 30% porous, or at least 35% porous. In some embodiments, the initial ceramic substrate 110 is less than 5% porous, less than 10% porous, less than 15% porous, less than 20% porous, less than 25% porous, less than 30% porous, or less than 35% porous.

In some embodiments, the porosity of the initial ceramic substrate 110 is at least 50% open pores 114, at least 60% open pores 114, at least 70% open pores 114, at least 80% open pores 114, at least 90% open pores 114, less than 90% open pores 114, less than 80% open pores 114, less than 70% open pores 114, or less than 60% open pores 114.

In some embodiments, the porosity of the initial ceramic substrate 110 can be 75% open pores 114 and 20% porous. For this example, the initial ceramic substrate 110 has 15% open pores 114 and 5% closed pores 112. In some embodiments, the porosity of the initial ceramic substrate 110 can be 80% open pores 114 and 20% porous. For this example, the initial ceramic substrate 110 has 16% open pores 114 and 4% closed pores 112.

The removable area 116 is ground away to produce ground ceramic substrate 120. In some embodiments, a planarization operation, such as chemical mechanical polishing (CMP) or grinding, may be used to remove the removable area 116. In some embodiments, grinding is a mechanical grinding. In some embodiments, grinding is mechanical grinding, machining, ground-machining, electrostatic discharge machining, or combinations thereof.

The ground ceramic substrate 120 includes an upper crust 122, closed pores 112, and open pores 114. The open pores 114 are dispersed throughout ground ceramic substrate 120, including the upper crust 122. In contrast, the closed pores 112 are not dispersed in the upper crust 122 of the ground ceramic substrate 120. The closed pores 112 are dispersed in the portion of the ground ceramic substrate 120 below the upper crust 122.

The upper crust 122 extends down into the ground ceramic substrate 120 less than two thousandths of an inch, less than three thousandths of an inch, less than four thousandths of an inch, less than five thousandths of an inch, less than six thousandths of an inch, more than two thousandths of an inch, more than three thousandths of an inch, more than four thousandths of an inch, more than five thousandths of an inch, or more than six thousandths of an inch. Below the upper crust 122, the closed pores 112 exist in the ground ceramic substrate 120. In the upper crust 122, the closed pores 112 do not exist.

Silicon is infiltrated throughout the ground ceramic substrate 120 to form a silicon-infiltrated ceramic substrate 130. The silicon is infiltrated throughout the silicon-infiltrated ceramic substrate 130, including the open pores 114 of the upper crust 122. Silicon is not infiltrated into the closed pores 112.

In some embodiments, the silicon for infiltrating includes pure silicon or silicon with impurities. In some embodiments, the silicon for infiltrating includes particles of single-crystal silicon or larger chunks of single-crystal silicon.

Infiltrating is when a material fills the pores of another material.

The silicon-infiltrated ceramic substrate 130 is polished to form a polished ceramic substrate 140. The upper crust 122 of the silicon-infiltrated ceramic substrate 130 is ground down to form a polished surface 142.

In some embodiments, polishing includes mechanical polishing or chemical mechanical polishing. In some embodiments, polishing is accomplished by robotic polishing.

In some embodiments, the polished surface 142 has a porosity with an average pore size of 70 microns, an average pore size of 60 microns, an average pore size of 50 microns, an average pore size of 40 microns, an average pore size of 30 microns, an average pore size of 20 microns, or an average pore size of 10 microns. In some embodiments, the average pore size ranges from 70 microns to 10 microns, 50 microns to 20 microns, 50 microns to 30 microns, or 40 microns to 20 microns.

In some embodiments, the average pore size is measured by a scanning electron microscope (SEM).

In some embodiments, the polished surface 142 extends less than 150 microns, less than 140 microns, less than 130 microns, less than 120 microns, less than 110 microns, less than 100 microns, less than 90 microns, less than 80 microns, less than 70 microns, less than 60 microns, less than 50 microns, less than 40 microns, less than 30 microns, or less than 20 microns into the polished ceramic substrate 140. In some embodiments, the polished surface 142 extends more than 150 microns, more than 140 microns, more than 130 microns, more than 120 microns, more than 110 microns, more than 100 microns, more than 90 microns, more than 80 microns, more than 70 microns, more than 60 microns, more than 50 microns, more than 40 microns, more than 30 microns, or more than 20 microns into the polished ceramic substrate 140.

In some embodiments, polishing the silicon-infiltrated ceramic substrate 130 includes polishing to have a surface finish of less than 150 angstroms root-mean-squared, less than 100 angstroms root-mean-squared, less than 50 angstroms root-mean-squared, more than 150 angstroms root-mean-squared, more than 100 angstroms root-mean-squared, or more than 50 angstroms root-mean-squared.

In some embodiments, polishing the silicon-infiltrated ceramic substrate 130 includes polishing to have a surface figure of less than 600 nm, less than 500 nm, less than 400 nm, less than 300 nm, less than 200 nm, or less than 100 nm, more than 600 nm, more than 500 nm, more than 400 nm, more than 300 nm, more than 200 nm, or more than 100 nm.

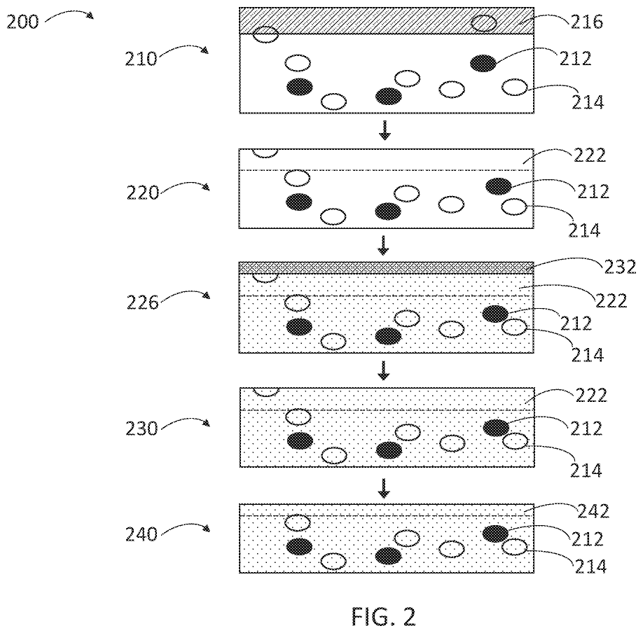

FIG. 2 depicts a non-limiting embodiment of a method 200 of the present disclosure described herein. The method 200 is a similar method as method 100. For the sake of brevity, similarities between the method 100 and the method 200 will not be discussed. Similar reference numerals between the figures represent the same components.

When infiltrating the ground ceramic substrate 220 with silicon, the excess silicon 232 forms an excess silicon-infiltrated ceramic substrate 226. The excess silicon 232 may surround all or a portion of the excess silicon-infiltrated ceramic substrate 226. In some embodiments, the excess silicon 232 forms a top layer on the excess silicon-infiltrated ceramic substrate 226.

The excess silicon-infiltrated ceramic substrate 226 can be reheated to remove the excess silicon 232. In some embodiments, all or substantially all of the excess silicon 232 is removed from the excess silicon-infiltrated ceramic substrate 226. In some embodiments, the excess silicon-infiltrated ceramic substrate 226 may need to be heated more than once to remove the excess silicon 232. Once the excess silicon 232 is removed from the excess silicon-infiltrated ceramic substrate 226, the silicon-infiltrated ceramic substrate 230 is formed.

In some embodiments, the excess silicon-infiltrated ceramic substrate 226 can be allowed to cool down for a predetermined amount of time. In some embodiments, after the predetermined amount of time elapses, a decision can be made as to whether excess silicon 232 needs to be removed. In some embodiments, the excess silicon-infiltrated ceramic substrate 226 can cool one hour, several hours, a day, or several days.

In some embodiments, the excess silicon 232 is removed by heating the excess silicon-infiltrated ceramic substrate 226 with a wicking element below the excess silicon-infiltrated ceramic substrate 226. After being heated, the excess silicon 232 flows to a wicking element (an element devoid of silicon, such as a chunk or rod of silicon carbide).

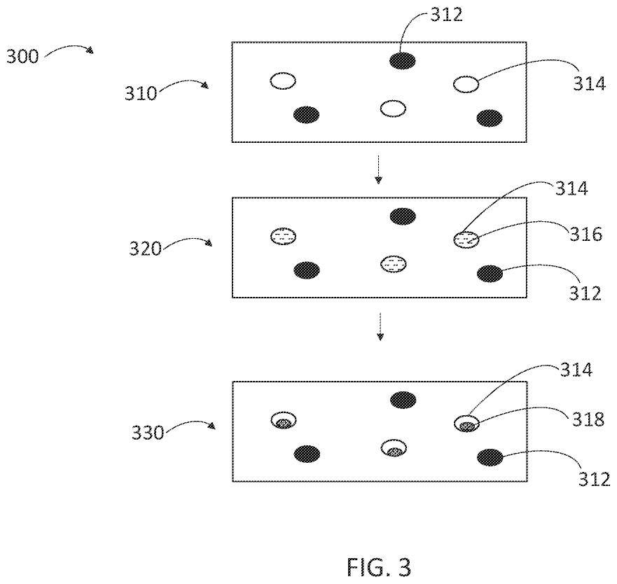

FIG. 3 depicts a non-limiting embodiment of a method 300 of the present disclosure described herein. In some embodiments, the method 300 includes filling open pores of the ceramic substrate are formed with carbon powder before infiltrating with silicon.

The method 300 includes an initial substrate 310 with closed pores 312 and open pores 314. The initial substrate 310 can be infiltrated with a carbon-based resin liquid 316 to form a carbon-based resin liquid filled substrate 320. The open pores 314 are filled with carbon-based resin liquid 316. In some embodiments, all or substantially all of the open pores 314 are filled with carbon-based resin liquid 316. In some embodiments, only a portion (e.g., less than 50%) of the open pores 314 are filled with carbon-based resin liquid 316.

In some embodiments, the carbon-based resin liquid 316 can be any carbon-based resin liquid such as a phenolic resin.

In some embodiments, the carbon powder 318 can be any carbon powder including a pyrolyzed carbon.

After the carbon-based resin liquid 316 is filled in the open pores 314, the carbon-based resin liquid filled substrate 320 can be heated to form a carbon powder 318 in the open pores 314

The steps of method 300 can occur before or after pre-grinding a substrate. For example, the steps of forming the carbon powder 318 in the open pores 314 can be used on the pre-ground ceramic substrate initial ceramic substrate 110 and/or ground ceramic substrate 120. For example, the steps of forming the carbon powder 318 in the open pores 314 can be used on the pre-ground ceramic substrate 210 and/or ground ceramic substrate 220.

After infiltrating silicon into the open pores 314 with the carbon powder 318, the silicon can react with the carbon powder 318 to form silicon carbide within the pores.

### ASPECTS

Various Aspects are described below. It is to be understood that any one or more of the features recited in the following Aspect(s) can be combined with any one or more other Aspect(s).

Aspect 1. A method of forming a polished surface: grinding an initial ceramic substrate to form a ground ceramic substrate; infiltrating the ground ceramic substrate with silicon; and polishing the silicon-infiltrated ceramic substrate, thereby forming the polished surface of the polished silicon-infiltrated ceramic substrate.

Aspect 2. The method of forming the polished surface of Aspect 1, wherein polishing the silicon-infiltrated ceramic substrate comprises polishing to have a surface finish of less than 150 angstroms root-mean-squared.

Aspect 3. The method of forming the polished surface of Aspect 1, wherein polishing the silicon-infiltrated ceramic substrate comprises polishing to have a surface finish of less than 100 angstroms root-mean-squared.

Aspect 4. The method of forming the surface as in any of the preceding Aspects, wherein polishing the silicon-infiltrated ceramic substrate comprises polishing to have a surface figure of less 500 nm.

Aspect 5. The method of forming the polished surface as in any one of Aspects 1, 2, or 3, wherein polishing the silicon-infiltrated ceramic substrate comprises polishing to have a surface figure of less 200 nm.

Aspect 6. The method of forming the polished surface as in any of the preceding Aspects, further comprising, after infiltrating the ground ceramic substrate with silicon, removing excess silicon.

Aspect 7. The method of forming the polished surface as in any of the preceding Aspects, wherein the polished surface comprises a porosity with an average pore size ranging from 50 microns to 20 microns.

Aspect 8. The method of forming the polished surface as in any one of Aspects 1-7, wherein the polished surface comprises a porosity with an average pore of size of 50 microns.

Aspect 9. The method of forming the polished surface as in any one of Aspects 1-7, wherein the polished surface comprises a porosity with an average pore of size of 30 microns.

Aspect 10. The method of forming the polished surface as in any one of Aspects 1-7, wherein the polished surface comprises a porosity with an average pore of size of 20 microns.

Aspect 11. The method of forming the polished surface as in any of the preceding Aspects, wherein the polished surface extends less than 100 microns into the polished silicon-infiltrated ceramic substrate.

Aspect 12. The method of forming the polished surface of as in any of the preceding Aspects, wherein grinding the initial ceramic substrate to form the ground ceramic substrate comprises grinding the ground ceramic substrate to be less than 4 thousandths of an inch.

Aspect 13. A method of forming a polished surface: grinding an initial ceramic substrate to form a ground ceramic substrate; forming silicon carbide within pores of the ground ceramic substrate, thereby forming a silicon-infiltrated ceramic substrate; and polishing the silicon-infiltrated ceramic substrate, thereby forming the polished surface of the polished silicon-infiltrated ceramic substrate.

Aspect 14. The method of forming the polished surface of Aspect 13, wherein forming the silicon carbide within the pores comprises: infiltrating the ground ceramic substrate with a carbon-based resin liquid; heating the ground ceramic substrate with the carbon-based resin liquid to form carbon powder in pores of the ground ceramic substrate; infiltrating the pores of the ground ceramic substrate with silicon; and reacting the silicon with the carbon powder to form the silicon carbide within the pores.

Aspect 15. The method of forming the polished surface of Aspects 13 or 14, wherein polishing the silicon-infiltrated ceramic substrate comprises polishing to have a surface finish of less than 150 angstroms root-mean-squared.

Aspect 16. The method of forming the polished surface of Aspects 13 or 14, wherein polishing the silicon-infiltrated ceramic substrate comprises polishing to have surface finish of less than 100 angstroms root-mean-squared.

Aspect 17. The method of forming the polished surface as in any of the preceding Aspects, wherein polishing the silicon-infiltrated ceramic substrate comprises polishing to have a surface figure of less 500 nm.

Aspect 18. The method of forming the polished surface as in any one of Aspects 13-16, wherein polishing the silicon-infiltrated ceramic substrate comprises polishing to have a surface figure of less 200 nm.

Aspect 19. The method of forming the polished surface as in any of the preceding Aspects, further comprising, after infiltrating the ground ceramic substrate with silicon, removing excess silicon.

Aspect 20. The method of forming the polished surface as in any of the preceding Aspects, wherein the polished surface comprises porosity with an average pore size ranging from 50 microns to 20 microns.

Aspect 21. The method of forming the polished surface of as in any one of Aspects 13-19, wherein the polished surface comprises a porosity with an average pore of size of 30 microns.

Aspect 22. The method of forming the polished surface of as in any one of Aspects 13-198, wherein the polished surface comprises a porosity with an average pore of size of 20 microns.

Aspect 23. The method of forming the polished surface as in any of the preceding Aspects, wherein the polished surface extends less than 100 microns into the polished silicon-infiltrated ceramic substrate.

Aspect 24. The method of forming the polished surface as in any of the preceding Aspects, wherein grinding the initial ceramic substrate to form the ground ceramic substrate comprises grinding the ground ceramic substrate to be less than 4 thousandths of an inch.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method of forming a polished surface, the method comprising:
grinding an initial ceramic substrate to form a ground ceramic substrate;
infiltrating the ground ceramic substrate with silicon; and
polishing the silicon-infiltrated ceramic substrate, thereby forming the polished surface of the polished silicon-infiltrated ceramic substrate.

2. The method of forming the polished surface of claim 1,
wherein polishing the silicon-infiltrated ceramic substrate comprises polishing to have a surface finish of less than 150 angstroms root-mean-squared.

3. The method of forming the polished surface of claim 1,
wherein polishing the silicon-infiltrated ceramic substrate comprises polishing to have a surface finish of less than 100 angstroms root-mean-squared.

4. The method of forming the surface of claim 1,
wherein polishing the silicon-infiltrated ceramic substrate comprises polishing to have a surface figure of less 500 nm.

5. The method of forming the polished surface of claim 1,
wherein polishing the silicon-infiltrated ceramic substrate comprises polishing to have a surface figure of less 200 nm.

6. The method of forming the polished surface of claim 1,
further comprising, after infiltrating the ground ceramic substrate with silicon, removing excess silicon.

7. The method of forming the polished surface of claim 1,
wherein the polished surface comprises a porosity with an average pore size ranging from 50 microns to 20 microns.

8. The method of forming the polished surface of claim 1,
wherein the polished surface comprises a porosity with an average pore of size of 50 microns.

9. The method of forming the polished surface of claim 1,
wherein the polished surface comprises a porosity with an average pore of size of 30 microns.

10. The method of forming the polished surface of claim 1,
wherein the polished surface comprises a porosity with an average pore of size of 20 microns.

11. The method of forming the polished surface of claim 1,
wherein the polished surface extends less than 100 microns into the polished silicon-infiltrated ceramic substrate.

12. The method of forming the polished surface of claim 1,
wherein grinding the initial ceramic substrate to form the ground ceramic substrate comprises grinding the ground ceramic substrate to be less than 4 thousandths of an inch.

13. A method of forming a polished surface, the method comprising:
grinding an initial ceramic substrate to form a ground ceramic substrate;
forming silicon carbide within pores of the ground ceramic substrate, thereby forming a silicon-infiltrated ceramic substrate; and
polishing the silicon-infiltrated ceramic substrate, thereby forming the polished surface of the polished silicon-infiltrated ceramic substrate.

14. The method of forming the polished surface of claim 13,
wherein forming the silicon carbide within the pores comprises:
infiltrating the ground ceramic substrate with a carbon-based resin liquid;
heating the ground ceramic substrate with the carbon-based resin liquid to form carbon powder in pores of the ground ceramic substrate;
infiltrating the pores of the ground ceramic substrate with silicon; and
reacting the silicon with the carbon powder to form the silicon carbide within the pores.

15. The method of forming the polished surface of claim 13,
wherein polishing the silicon-infiltrated ceramic substrate comprises polishing to have a surface finish of less than 150 angstroms root-mean-squared.

16. The method of forming the polished surface of claim 13,
wherein polishing the silicon-infiltrated ceramic substrate comprises polishing to have surface finish of less than 100 angstroms root-mean-squared.

17. The method of forming the polished surface of claim 13,
wherein polishing the silicon-infiltrated ceramic substrate comprises polishing to have a surface figure of less 500 nm.

18. The method of forming the polished surface of claim 13,
wherein polishing the silicon-infiltrated ceramic substrate comprises polishing to have a surface figure of less 200 nm.

19. The method of forming the polished surface of claim 13,
further comprising, after infiltrating the ground ceramic substrate with silicon, removing excess silicon.

20. The method of forming the polished surface of claim 13,
wherein the polished surface comprises porosity with an average pore size ranging from 50 microns to 20 microns.
